(19) United States
(12) Patent Application Publication
(10) Pub. No.: US 2020/0285879 A1
(43) Pub. Date: Sep. 10, 2020

(54) SCENE TEXT DETECTOR FOR UNCONSTRAINED ENVIRONMENTS

(71) Applicant: INTEL CORPORATION, Santa Clara, CA (US)

(72) Inventors: Wenhua Cheng, Beijing (CN); Anbang Yao, Beijing (CN); Libin Wang, Beijing (CN); Dongqi Cai, Beijing (CN); Jianguo Li, Beijing (CN); Yurong Chen, Beijing (CN)

(73) Assignee: INTEL CORPORATION, Santa Clara, CA (US)

(21) Appl. No.: 16/651,935

(22) PCT Filed: Nov. 8, 2017
(86) PCT No.: PCT/CN2017/109885

§ 371 Date: Mar. 27, 2020

(51) Int. Cl. G06K 9/32; G06K 9/46; G06K 9/62

(52) U.S. Cl. CPC G06K 9/325; G06K 9/46; G06K 9/6267; G06K 2209/01; G06K 9/6217

(57) ABSTRACT

A semiconductor package apparatus may include technology to apply a trained scene text detection network to an image to identify a core text region, a supportive text region, and a background region of the image, and detect text in the image based on the identified core text region and supportive text region. Other embodiments are disclosed and claimed.

### TECHNICAL FIELD

Embodiments generally relate to computer vision systems. More particularly, embodiments relate to a scene text detector for unconstrained environments.

### BACKGROUND

Text information in unconstrained environments may appear in a variety of places such as guide posts, product names, street numbers, etc., and such text may be quite useful in a person's daily life. Such text information may convey useful information about the environment. There may be two important steps in understanding scene text by a computer vision system. Namely, scene text detection (e.g., localizing the text) and scene text recognition. Due to complex backgrounds, variations of text font, size, color, orientation, etc., and variations of the environments, scene text detection for computer vision systems has much room for improvement.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor package apparatus according to an embodiment;

FIGS. 3A to 3C are flowcharts of an example of a method of detecting text according to an embodiment;

FIG. 4 is a block diagram of an example of scene text detector according to an embodiment;

FIG. 5 is a flowchart of an example of method of detecting scene text according to an embodiment;

FIG. 6 is a flowchart of an example of a method of training weights for a scene text detection network according to an embodiment;

FIG. 7A is an illustrative diagram of an example image of an unconstrained environment according to an embodiment;

FIG. 7B is an illustrative diagram of an example ground truth image according to an embodiment;

FIG. 8A is an illustrative diagram of an example test image according to an embodiment;

FIG. 8B is an illustrative diagram of an example network result image according to an embodiment;

FIG. 8C is an illustrative diagram of an example test result according to an embodiment;

FIG. 9 is a block diagram of an example of a scene text detection network according to an embodiment;

FIGS. 10A to 10E are block diagrams of another example of a scene text detection network according to an embodiment;

FIG. 11A is an illustrative diagram of another example network result image according to an embodiment;

FIG. 11B is an illustrative diagram of another example of detected scene text according to an embodiment;

FIG. 12A is an illustrative diagram of another example network result image according to an embodiment;

FIG. 12B is an illustrative diagram of another example of detected scene text according to an embodiment;

FIG. 13 is a flowchart of an example of a method of splitting words according to an embodiment;

FIGS. 14A and 14B are block diagrams of examples of scene text detection apparatuses according to embodiments;

FIG. 15 is a block diagram of an example of a processor according to an embodiment; and

FIG. 16 is a block diagram of an example of a system according to an embodiment.

### DESCRIPTION OF EMBODIMENTS

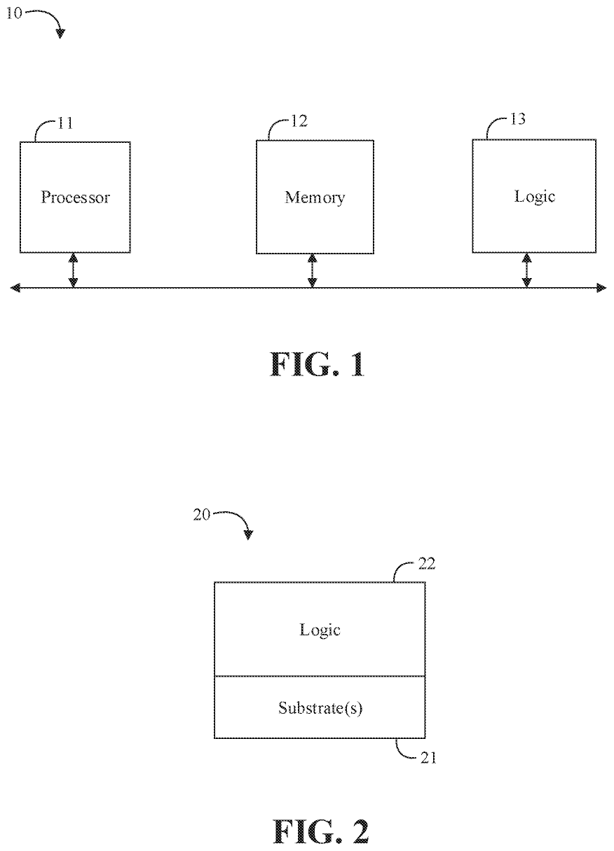

Turning now to FIG. 1, an embodiment of an electronic processing system 10 may include a processor 11, memory 12 communicatively coupled to the processor 11, and logic 13 communicatively coupled to the processor 11 to apply a trained scene text detection network to an image to identify a core text region, a supportive text region, and a background region of the image, and detect text in the image based on the identified core text region and supportive text region. In some embodiments, the logic 13 may be further configured to split connected words into one or more word regions based on the identified core text region and supportive text region. For example, the logic 13 may also be configured to remove a word region in response to a lack of core text region pixels in the word region. In some embodiments, the logic 13 may be further configured to train the scene text detection network with a plurality of image training samples, the scene text detection network including a dense features portion, a reverse connections portion communicatively coupled to the dense features portion, and a stage losses portion communicatively coupled to the reverse connections portion. For example, the logic 13 may also be configured to support large receptive field features for the dense features portion, and/or to train the scene text detection network with a plurality of online hard examples (OHEM) mining training samples. For example, OHEM may include hard negatives mining.

Embodiments of each of the above processor 11, memory 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory 12, persistent storage media, or other system memory may store a set of instructions which when executed by the processor 11 cause the system 10 to implement one or more components, features, or aspects of the system 10 (e.g., the logic 13, to identifying a core text region, a supportive text region, and a background region of an image based on semantic segmentation, detecting text in the image based on the identified core text region and supportive text region, etc.).

Turning now to FIG. 2, an embodiment of a semiconductor package apparatus 20 may include one or more substrate(s) 21, and logic 22 coupled to the substrate(s) 21, wherein the logic 22 may be at least partly implemented in one or more of configurable logic and fixed-functionality hardware logic. The logic 22 coupled to the substrate(s) 21 may be configured to apply a trained scene text detection network to an image to identify a core text region, a supportive text region, and a background region of the image, and detect text in the image based on the identified core text region and supportive text region. In some embodiments, the logic 22 may be further configured to split connected words into one or more word regions based on the identified core text region and supportive text region. For example, the logic 22 may also be configured to remove a word region in response to a lack of core text region pixels in the word region. In some embodiments, the logic 22 may be further configured to train the scene text detection network with a plurality of image training samples, the scene text detection network including a dense features portion, a reverse connections portion communicatively coupled to the dense features portion, and a stage losses portion communicatively coupled to the reverse connections portion. For example, the logic 22 may also be configured to support large receptive field features for the dense features portion, and/or to train the scene text detection network with a plurality of online hard examples mining training samples.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

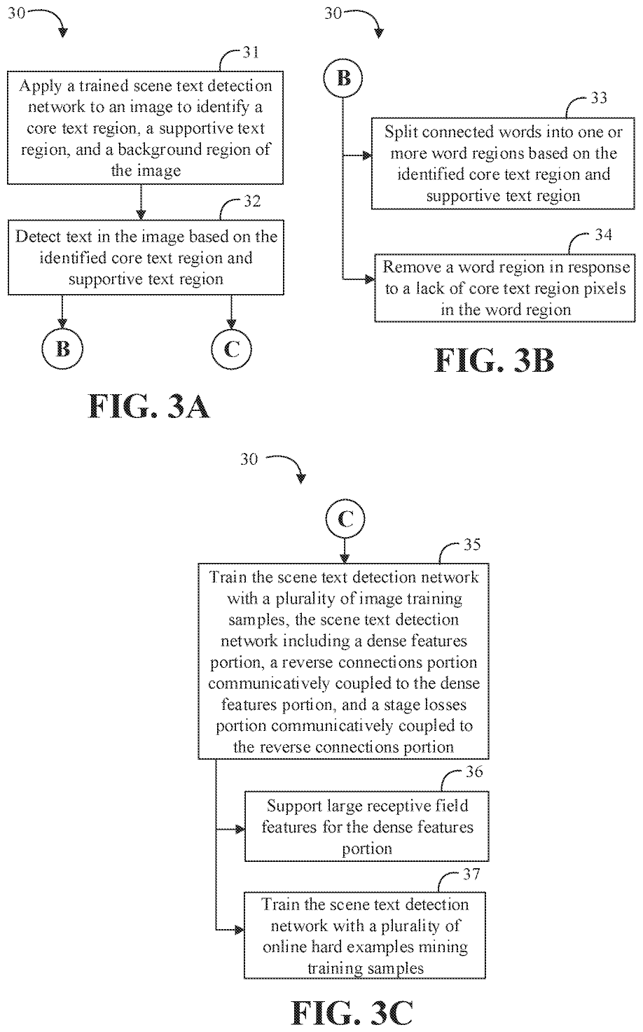

Turning now to FIGS. 3A to 3C, an embodiment of a method 30 of detecting to text may include applying a trained scene text detection network to an image to identify a core text region, a supportive text region, and a background region of the image at block 31, and detecting text in the image based on the identified core text region and supportive text region at block 32. Some embodiments of the method 30 may further include splitting connected words into one or more word regions based on the identified core text region and supportive text region at block 33, and/or removing a word region in response to a lack of core text region pixels in the word region at block 34. Some embodiments of the method 30 may further include training the scene text detection network with a plurality of image training samples, the scene text detection network including a dense features portion, a reverse connections portion communicatively coupled to the dense features portion, and a stage losses portion communicatively coupled to the reverse connections portion at block 35. For example, the method 30 may also include supporting large receptive field features for the dense features portion at block 36, and/or training the scene text detection network with a plurality of online hard examples mining training samples at block 37.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in firmware, applications (e.g., through an application programming interface (API)), or driver software running on to an operating system (OS).

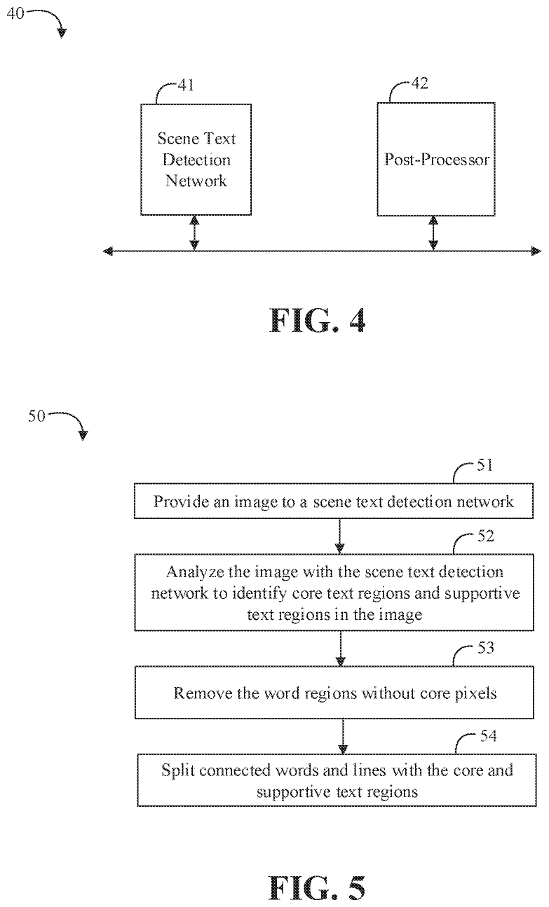

Turning now to FIG. 4, an embodiment of a scene text detector 40 may include a scene text detection network 41 communicatively coupled to a post-processor 42. The scene text detection network 41 may include technology to identify a core text region, a supportive text region, and a background region of an image based on semantic segmentation, and the post-processor 42 may include technology to detect text in the image based on the identified core text region and supportive text region. A computer vision system may use detected scene text for many applications including autonomous driving cars, Internet of Things (IoT), text translation, player identification in sports, geo-location, image retrieval, exercise searching for online education, daily assistant for the blind, and so on. In some embodiments, the post-processor 42 may be configured to split connected words into one or more word regions based on the identified core text region and supportive text region. For example, the post-processor 42 may also be configured to remove a word region in response to a lack of core text region pixels in the word region. In some embodiments, the scene text detection network 41 may include a dense features portion, a reverse connections portion communicatively coupled to the dense features portion, and a stage losses portion communicatively coupled to the reverse connections portion. For example, the scene text detection network 41 may also be configured to support large receptive field features for the dense features portion. In some embodiments, the scene text detection network 41 may be trained with a plurality of online hard examples mining training samples.

Embodiments of the scene text detection network 41, the post-processor 42, and other components of the scene text detector 40, may be implemented in hardware, software, or any combination thereof. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented to programming language such as PYTHON, PERL, JAVA, SMALLTALK, C++, C# or the like and conventional procedural programming languages, such as the “C” programming language or similar programming languages.

Some embodiments may advantageously provide scene text detection in unconstrained environments. For example, some embodiments may divide text regions into two or more parts including a core text region and supportive regions. Identifying a core text region may be particularly useful for scene text detection because the more central or core part of text regions may be more likely to be pure text, while the supportive part may be mixed with different background information. Some embodiments may utilize a fully convolutional neural network (FCN) framework for unconstrained scene text detection. For example, a suitably trained FCN may create a scene text detection network. An input image may be provided to the scene text detection network to separate core text regions and supportive text regions from the background region of the image in a semantic segmentation formulation.

Some embodiments may provide an end-to-end learning framework which may separate core text regions and supportive text regions from background image information based on semantic segmentation. Advantageously, providing an additional segmentation class for the supportive text region may improve the scene text detection results. As compared to some other scene text detection techniques, some embodiments may involve much simpler post-processing which may be readily implemented in an end-to-end framework (e.g., on a mobile or edge device). For example, some embodiments may provide better performance with near real-time processing speed. Some embodiments may provide a software stack for text-based visual analytics which may be utilized for a variety of applications including autonomous driving cars, IoT (e.g., a self-service store), player identification in sports, exercise searching for online children's education, text translation for travelers, image retrieval, daily assistant for blind or visual impaired person, and so on.

Turning now to FIG. 5, an embodiment of a method 50 of detecting scene text may include providing an image to a scene text detection network at block 51, analyzing the image with the scene text detection network to identify core text regions and supportive text regions in the image at block 52, removing the word regions without core pixels at block 53, and splitting connected words and lines with the core and supportive text regions as block 54. For example, an embodiment of a scene text detection technique may be transformed to a semantic segmentation technique. Rather than considering all text pixels as the same class, some embodiments may treat core text parts and supportive pixels as different classes (e.g., because core text regions may be more likely to be most informative with pure text, while border text parts may be mixed with background information to provide context support).

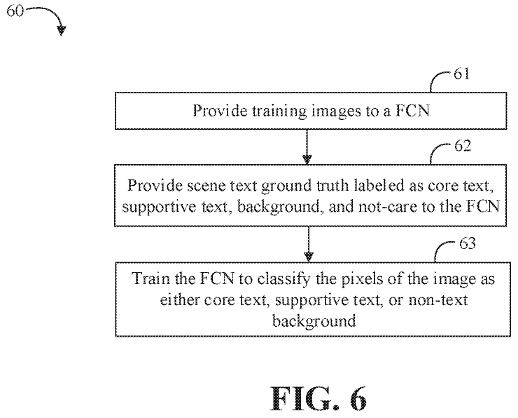

Turning now to FIG. 6, an embodiment of a method 60 of training weights for a scene text detection network may include providing training images to a FCN at block 61, providing scene text ground truth labeled as core text, supportive text, background, and not-care to the FCN at block 62, and training the FCN to classify the pixels of the image as either core text, supportive text, or non-text background at block 63. The target is to classify every pixel into one of three classes of core-text, supportive-text and non-text background. The pixel ground truth of the core-text, supportive-text, and not-care regions may be generated by rotated boxes. Utilizing rotated boxes annotation rather than pixel labeling annotations may reduce the amount of manual effort needed to generate the ground truth labels. During training, the not-care ground truth may not be used in computing loss functions (e.g., because they may confuse the network). For example, the not-care ground truth may include pixels of an incomplete text and/or pixels at outer borders of text which may not be possible to accurately annotate. In some embodiments, the size of a core text region may be proportional to that of the whole text region. For example, if a text region ranges from −0.5 to 0.5, then the core text region may range from −0.2 to 0.2. During testing, the word regions without core pixels may be removed. The FCN may be trained with OHEM (e.g., OHEM may be embedded in the training procedure). Adopting OHEM in every stage may make the stages somewhat cascaded, but may advantageously ignore some very hard examples to ease the training.

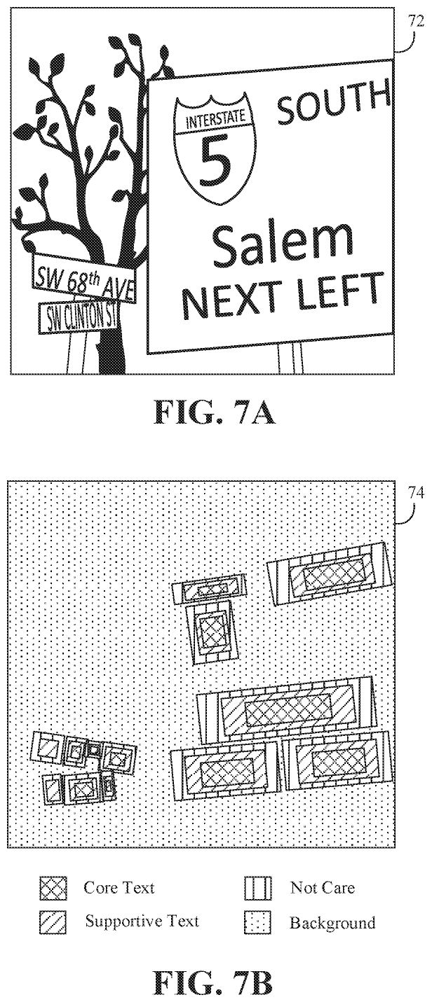

Turning now to FIGS. 7A and 7B, an example image 72 (FIG. 7A) of an unconstrained environment may include various street signs against a background of a tree and sky. Ground truth information 74 (FIG. 7B) may correspond to the image 72 and may label regions as one of four classes including core-text, supportive-text, not-care, and non-text background, denoted by different hatch patterns as indicated in FIG. 7B (e.g., generated by rotated box annotations). Note that the ground truth training information may include four classifications while the output results may to only provide the three classifications because the output results do not include the not-care classification. In accordance with some embodiments, many such unconstrained images and corresponding ground truth information may be utilized to train the scene text detection network. Those skilled in the art will appreciate that the training images may comprise photographs, video frames, and/or other digital images where the text may not be as crisp and the backgrounds may be much more complex than the illustrative example of FIG. 7A.

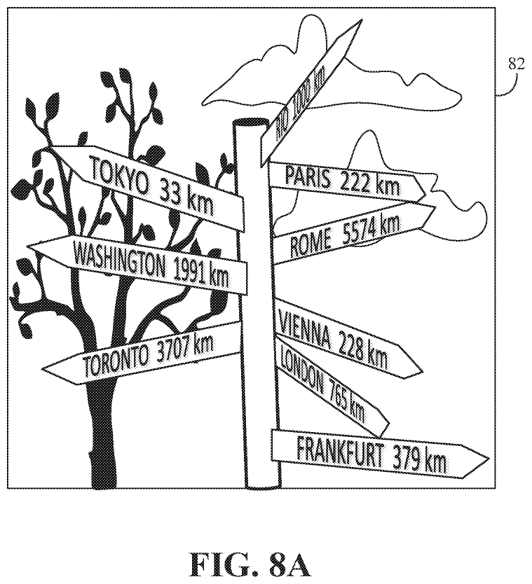

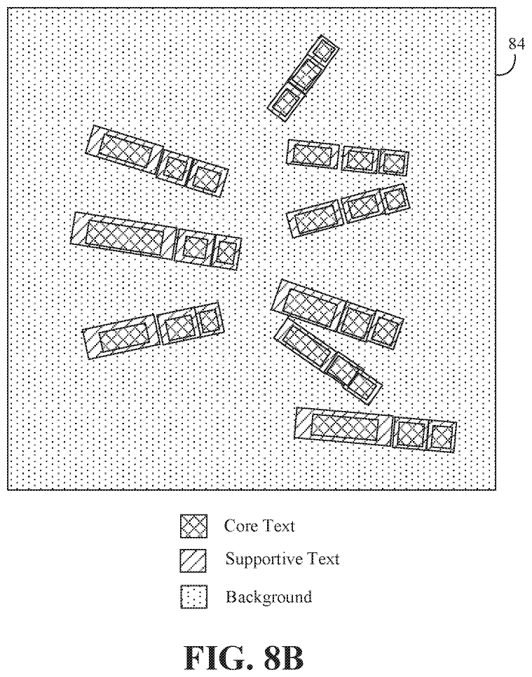

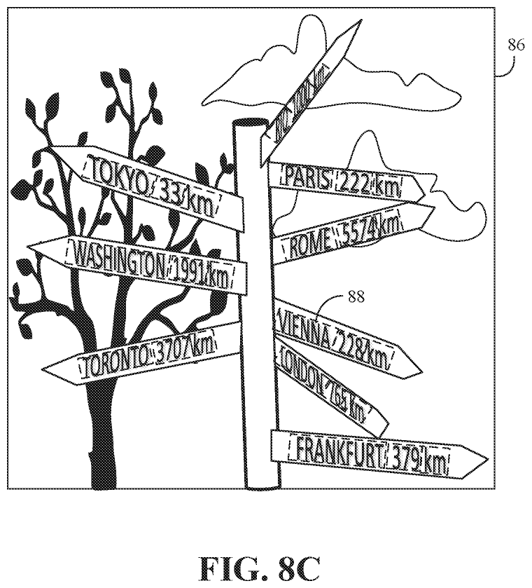

Turning now to FIGS. 8A to 8C, an example test image 82 of an unconstrained environment may include a guide post against a background of a tree and sky (e.g., with clouds). The test image 82 may be provided to a trained scene text detection network to produce a network result image 84 with every pixel of the network result image 84 classified as either core text, supportive text, or non-text background, denoted by different hatch patterns as indicated in FIG. 8B. For example, the network result image 84 may be considered as a core and supportive pixel mask (e.g., or a center and border pixel mask). The test image 82 and the network result image 84 may be post-processed to detect the scene text as shown in an illustrative test result 86 in FIG. 8C. For example, the post-processing may construct a bounding box 88 for each detected text in the test image 82. In some embodiments, the precision may be advantageously improved in the testing phase by removing the word regions without core pixels (e.g., rather than score-based post-processing). Those skilled in the art will appreciate that the testing images may comprise photographs, video images, and/or other digital images where the text may not be as crisp and the backgrounds may be much more complex than the illustrative example of FIG. 8A.

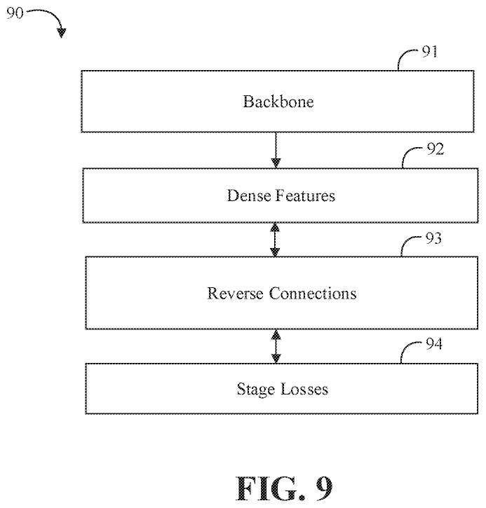

Turning now to FIG. 9, an embodiment of a scene text detection network 90 may include a backbone portion 91 communicatively coupled to a dense features portion 92. The network 90 may include a reverse connections portion 93 coupled between the dense features portion 92 and a stage losses portion 94. The backbone portion 91 may include any suitable backbone which supports stages, such as VGG, RESNET, DENSENET, etc. The architecture of the network 90 for scene text detection may leverage several building blocks for the object detection task such as dense features, reverse layer connections, and multi-stage losses. The dense features portion 90 may be utilized as a basic component to represent the information in each stage, and may include larger receptive fields. The reverse connections portion 93 may leverage semantic information from previous layers or stages. The multi-stage to losses may fuse output from a different scale for better accuracy. OHEM may be adopted during the training procedure, to make each stage focus on the hardest examples.

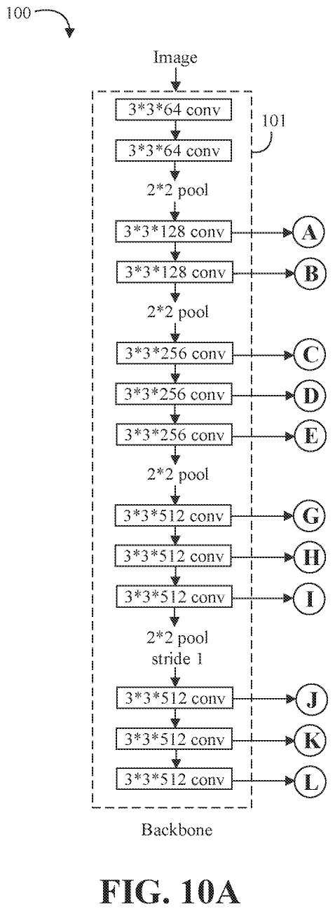

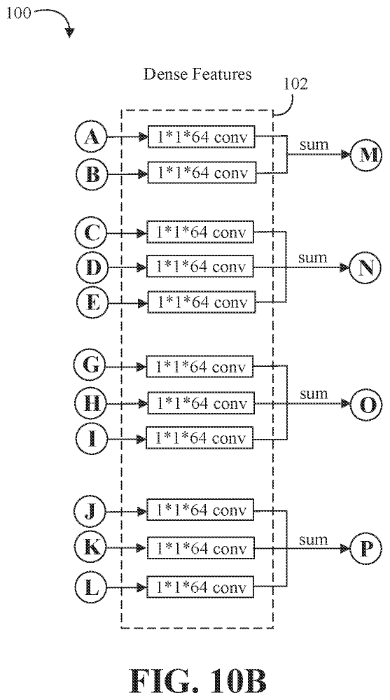

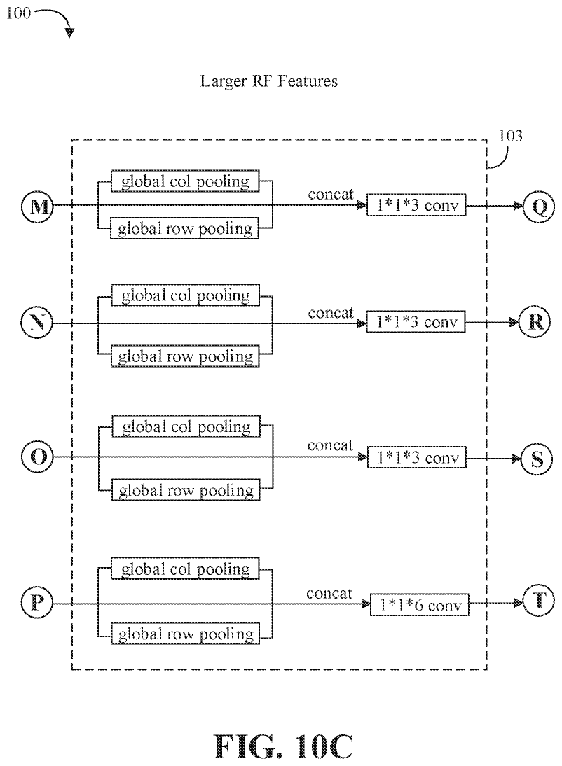

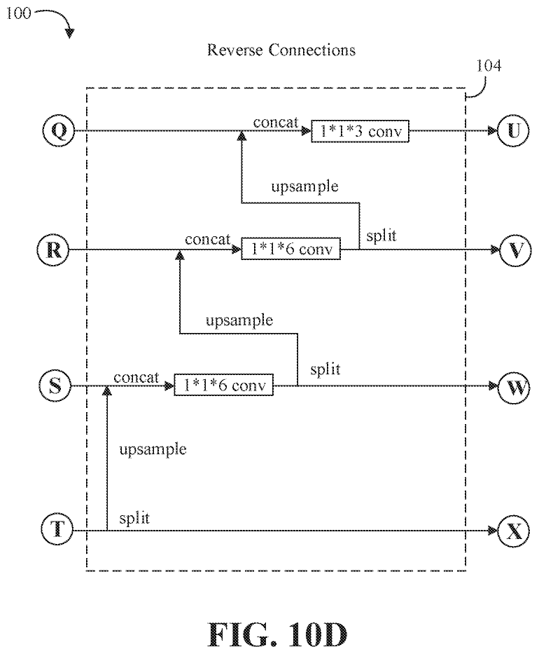

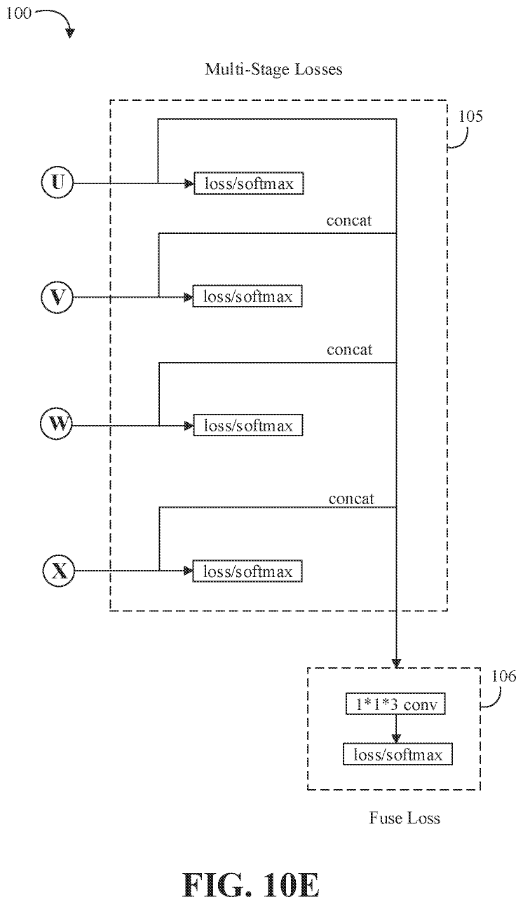

Turning now to FIGS. 10A to 10E, an embodiment of a scene text detection network 100 may include multiple stages/layers coupled to each other across FIGS. 10A to 10E as indicated by corresponding circled letters A through X. A VGG-16 backbone 101 may be coupled to a dense features stage 102. The convolution layers of the VGG-16 backbone 101 may be split into 5 stages, separated by pooling-layers. The useful information obtained by each convolution layer may become coarser as the receptive field size increases. Some embodiments may only adopt the later 4 stages, because the receipt field of the first stage may be too small and the computing cost may be relative higher. The dense features portion 102 may provide the basic component to represent the information in each stage. For computer vision, for example, the dense features portion 102 may include larger receptive field (RF) features 103. In some embodiments, the receptive field of each stage may be increased greatly while the computation cost may be low or negligible. For example, some embodiments may add another two branches next to the dense features portion 102, global row pooling, and global column pooling respectively. For global row pooling and for an arbitrarily sized feature map, some embodiments may find the maximum value in each row, and then resize the row to the same size as the feature map. A reverse connections portion 104 may be coupled between the dense features portion 102 and a multi-stage losses portion 105 to provide reverse connections to bring semantic information from the former layers to current layer and increase the information flow among stages. The multi-stage losses portion 105 may provide multi-stage losses to a fuse loss portion 106 to fuse output from different stages (e.g., also scales) for better accuracy. Advantageously, the structure and combinations of these blocks may provide a hierarchical, larger receipt field (e.g., field of view) and semantic features in a holistic framework in which all or most of the parameters are learned end-to-end. In some embodiments, because different stages may have different hard examples, OHEM may be utilized to focus on the hardest examples in every stage. Some embodiments may advantageously provide a relatively small model size (e.g., only about 60 MB).

Post-Processing Examples

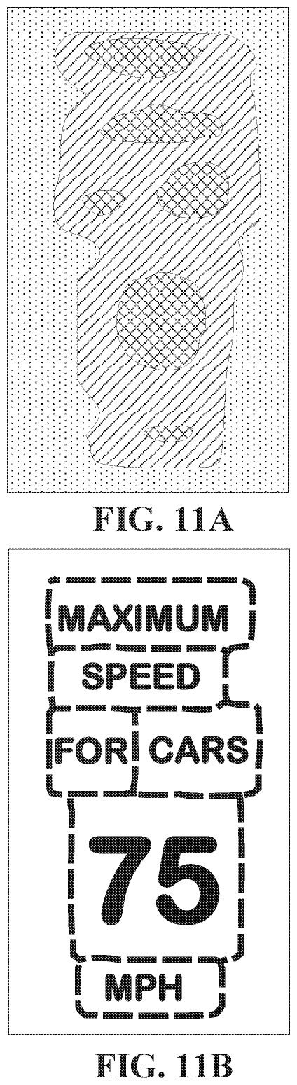

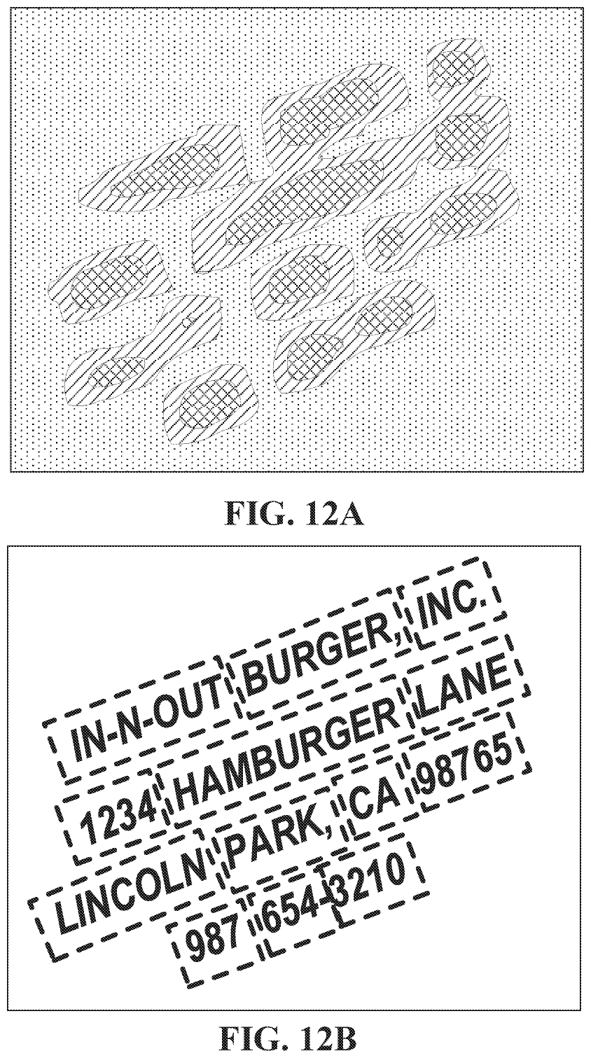

Turning now to FIGS. 11A to 11B and FIGS. 12A to 12B, respective embodiments of scene text detection network results (FIGS. 11A and 12A, with the same key for the hatch patterns as FIG. 8B) and corresponding images with bounding boxes around detected scene text (FIGS. 11B and 12B) show how some words or lines may be connected together in an unconstrained environment. Some embodiments may provide a simple but effective technique for cutting the connected regions into words. Some embodiments may be based on all of the connected words having the same orientation, which may true in most practical scenarios.

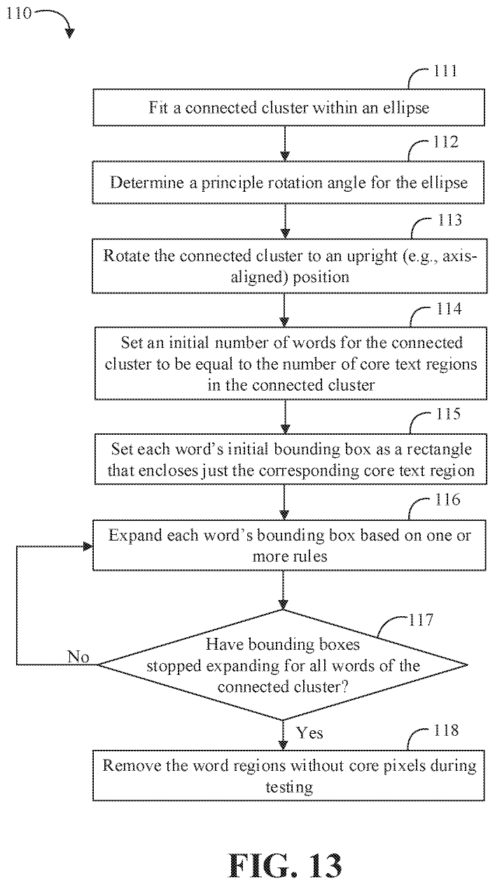

Turning now to FIG. 13, an embodiment of a method 110 of splitting words may include fitting a connected cluster within an ellipse at block 111, determining a principle rotation angle for the ellipse at block 112, and rotating the connected cluster to an upright (e.g., axis-aligned) position at block 113. For example, a connected cluster may correspond to a group of core text regions and/or supportive text regions which are touching each other in the scene text detection network results. The method 110 may then set an initial number of words for the connected cluster to be equal to the number of core text regions in the connected cluster at block 114, and may then set each word's initial bounding box as a rectangle that encloses just the corresponding core text region at block 115. The method 110 may then expand each word's bounding box based on one or more rules at block 116.

For example, some embodiments may expand a word's borders (e.g., left, right, up, down) based on the following rules: a) the distance of border expanding may be proportional to the core-region size (e.g., the distance of left and right border expanding may be proportional to the width of the core text region, while the distance of up and down border expanding may be proportional to the height of the core text region); b) if the border meets with any border of other words after expanding, then the current expansion is canceled, and no further expansion is made in that direction; c) if the word rectangle does not introduce additional supportive text pixels after expanding, then the current expansion is canceled, and no further expansion is made in that direction. The method 110 may determine if the bounding boxes stopped expanding for all words of the connected cluster at block 117 and, if not, may return to block 116 to continue the expansion process for every word until all borders stop expansion. When the expansion has completed at block 117, the method 110 may then rotate each word rectangle back to its original direction at block 118.

Some embodiments of a scene text detector (e.g., a scene text detection network together with a post-processor) may provide good performance on the to COCO-Text challenge dataset. For example, some embodiments of a scene text detector may achieve an F-score of about 47.15% on the validation set with near real-time processing speed (e.g., about 15 fps on VGA input).

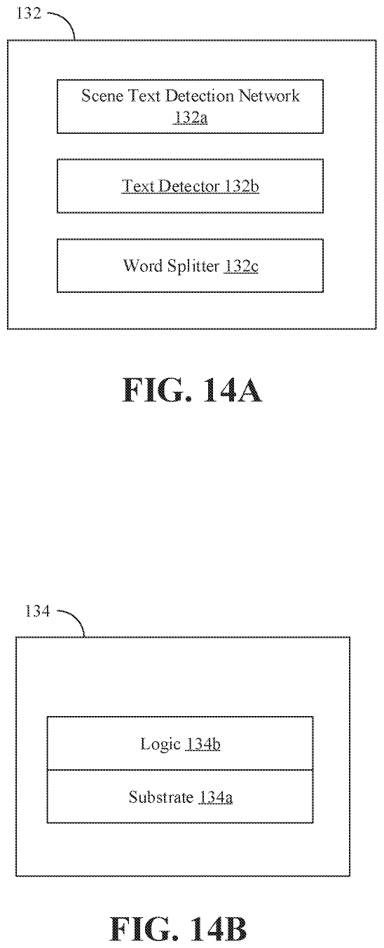

FIG. 14A shows a scene text detection apparatus 132 (132a-132c) that may implement one or more aspects of the method 30 (FIG. 3), the method 50 (FIG. 5), the method 60 (FIG. 6), and/or the method 110 (FIG. 13). The scene text detection apparatus 132, which may include logic instructions, configurable logic, fixed-functionality hardware logic, may be readily substituted for the logic 12 (FIG. 1), the logic 22 (FIG. 2), and/or the scene text detector 40 (FIG. 4), already discussed. A scene text detection network 132a may identify a core text region, a supportive text region, and a background region of an image based on semantic segmentation, and a text detector 132b may detect text in the image based on the identified core text region and supportive text region. A word splitter 132c may split connected words into one or more word regions based on the identified core text region and supportive text region. For example, the word splitter 132c may also remove a word region in response to a lack of core text region pixels in the word region. In some embodiments, the scene text detection network 132a may include a dense features portion, a reverse connections portion communicatively coupled to the dense features portion, and a stage losses portion communicatively coupled to the reverse connections portion. For example, the scene text detection network 132a may also support large receptive field features for the dense features portion. In some embodiments, the scene text detection network 132a may be trained with a plurality of online hard examples mining training samples.

Turning now to FIG. 14B, scene text detection apparatus 134 (134a, 134b) is shown in which logic 134b (e.g., transistor array and other integrated circuit/IC components) is coupled to a substrate 134a (e.g., silicon, sapphire, gallium arsenide). The logic 134b may generally implement one or more aspects of the method 30 (FIG. 3), the method 50 (FIG. 5), the method 60 (FIG. 6), and/or the method 110 (FIG. 13). Thus, the logic 134b may identify a core text region, a supportive text region, and a background region of an image based on semantic segmentation, and detect text in the image based on the identified core text region and supportive text region. In some embodiments, the logic 134b may split connected words into one or more word regions based on the identified core text region and supportive text region. For example, the logic 134b may also remove a word region in response to a lack of core text region pixels in the word region. In some embodiments, the logic 134b may also train the scene text detection network with a plurality of image training samples, the scene text detection network including a dense features portion, a reverse connections portion communicatively coupled to the dense features portion, and a stage losses portion communicatively coupled to the reverse connections portion. For example, the logic 134b may support large receptive field features for the dense features portion, and/or to train the scene text detection network with a plurality of online hard examples mining training samples. In one example, the apparatus 134 is a semiconductor die, chip and/or package.

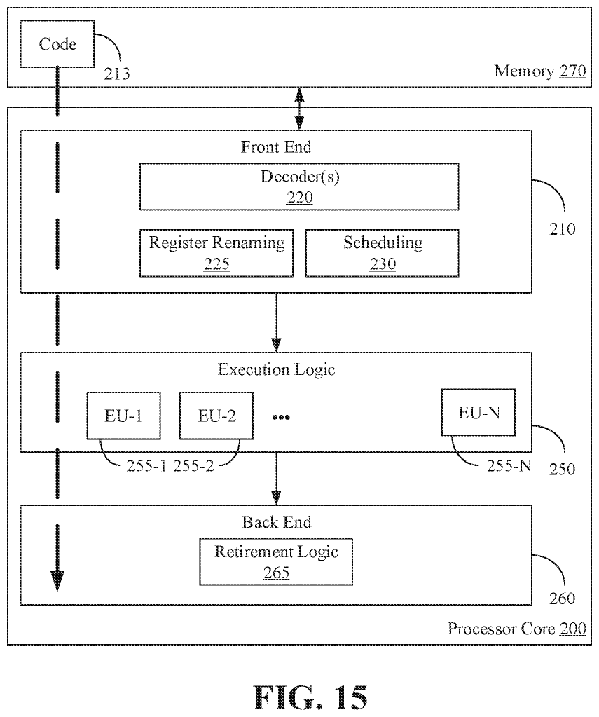

FIG. 15 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 15, a processing element may alternatively include more than one of the processor core 200 illustrated in FIG. 15. The processor core 200 may be a single-threaded core or, for at least one embodiment, the processor core 200 may be multithreaded in that it may include more than one hardware thread context (or “logical processor”) per core.

FIG. 15 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 30 (FIG. 3), the method 50 (FIG. 5), the method 60 (FIG. 6), and/or the method 110 (FIG. 13), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 15, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

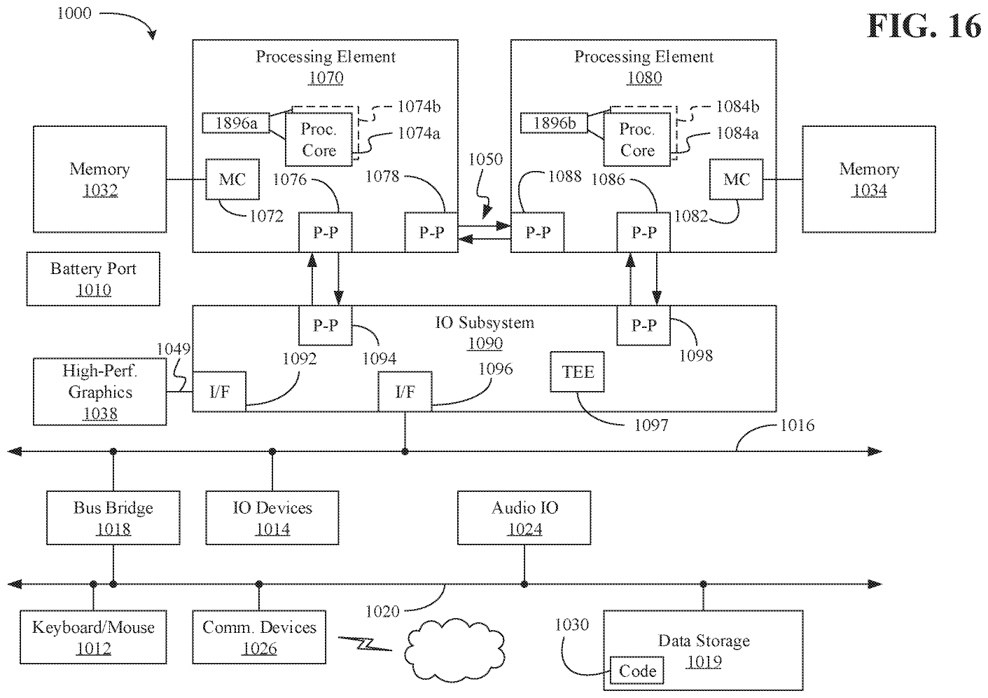

Referring now to FIG. 16, shown is a block diagram of a system 1000 embodiment in accordance with an embodiment. Shown in FIG. 16 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 16 may be implemented as a multi-drop bus rather than point-to-point interconnect.

As shown in FIG. 16, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 15.

Each processing element 1070, 1080 may include at least one shared cache 1896a, 1896b (e.g., static random access memory/SRAM). The shared cache 1896a, 1896b may store data (e.g., objects, instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 16, MC's 1072 and 1082 couple the processors to respective memories, namely a memory 1032 and a memory 1034, which may be portions of main memory locally attached to the respective processors. While the MC 1072 and to 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 16, the I/O subsystem 1090 includes a TEE 1097 (e.g., security controller) and P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 16, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement one or more aspects of the method 30 (FIG. 3), the method 50 (FIG. 5), the method 60 (FIG. 6), and/or the method 110 (FIG. 13), already discussed, and may be similar to the code 213 (FIG. 15), already discussed. Further, an audio I/O 1024 may be coupled to second bus 1020.

Note that other embodiments are contemplated. For example, instead of the point-to-point architecture of FIG. 16, a system may implement a multi-drop bus or another such communication topology.

### ADDITIONAL NOTES AND EXAMPLES

Example 1 may include an electronic processing system, comprising a processor, memory communicatively coupled to the processor, and logic communicatively coupled to the processor to apply a trained scene text detection network to an image to identify a core text region, a supportive text region, and a background region of the image, and detect text in the image based on the identified core text region and supportive text region.

Example 2 may include the system of Example 1, wherein the logic is further to split connected words into one or more word regions based on the identified core text region and supportive text region.

Example 3 may include the system of Example 1, wherein the logic is further to remove a word region in response to a lack of core text region pixels in the word region.

Example 4 may include the system of Example 1, wherein the logic is further to train the scene text detection network with a plurality of image training samples, the scene text detection network including a dense features portion, a reverse connections portion communicatively coupled to the dense features portion, and a stage losses portion communicatively coupled to the reverse connections portion.

Example 5 may include the system of Example 4, wherein the logic is further to support large receptive field features for the dense features portion.

Example 6 may include the system of any of Examples 4 to 5, wherein the logic is further to train the scene text detection network with a plurality of online hard examples mining training samples.

Example 7 may include a semiconductor package apparatus, comprising one or more substrates, and logic coupled to the one or more substrates, wherein the logic is at least partly implemented in one or more of configurable logic and fixed-functionality hardware logic, the logic coupled to the one or more substrates to apply a trained scene text detection network to an image to identify a core text region, a supportive text region, and a background region of the image, and detect text in the image based on the identified core text region and supportive text region.

Example 8 may include the apparatus of Example 7, wherein the logic is further to split connected words into one or more word regions based on the identified core text region and supportive text region.

Example 9 may include the apparatus of Example 7, wherein the logic is further to remove a word region in response to a lack of core text region pixels in the word region.

Example 10 may include the apparatus of Example 7, wherein the logic is further to train the scene text detection network with a plurality of image training samples, the scene text detection network including a dense features portion, a reverse connections portion communicatively coupled to the dense features portion, and a stage losses portion communicatively coupled to the reverse connections portion.

Example 11 may include the apparatus of Example 10, wherein the logic is further to support large receptive field features for the dense features portion.

Example 12 may include the apparatus of any of Examples 10 to 11, wherein the logic is further to train the scene text detection network with a plurality of online hard examples mining training samples.

Example 13 may include a method of detecting text, comprising applying a trained scene text detection network to an image to identify a core text region, a supportive text region, and a background region of the image, and detecting text in the image based on the identified core text region and supportive text region.

Example 14 may include the method of Example 13, further comprising splitting connected words into one or more word regions based on the identified core text region and supportive text region.

Example 15 may include the method of Example 13, further comprising removing a word region in response to a lack of core text region pixels in the word region.

Example 16 may include the method of Example 13, further comprising training the scene text detection network with a plurality of image training samples, the scene text detection network including a dense features portion, a reverse connections portion communicatively coupled to the dense features portion, and a stage losses portion communicatively coupled to the reverse connections portion.

Example 17 may include the method of Example 16, further comprising supporting large receptive field features for the dense features portion.

Example 18 may include the method of any of Examples 16 to 17, further comprising training the scene text detection network with a plurality of online hard examples mining training samples.

Example 19 may include at least one computer readable medium, comprising a set of instructions, which when executed by a computing device, cause the computing device to apply a trained scene text detection network to an image to identify a core text region, a supportive text region, and a background region of the image, and detect text in the image based on the identified core text region and supportive text region.

Example 20 may include the at least one computer readable medium of Example 19, comprising a further set of instructions, which when executed by the computing device, cause the computing device to split connected words into one or more word regions based on the identified core text region and supportive text region.

Example 21 may include the at least one computer readable medium of Example 19, comprising a further set of instructions, which when executed by the computing device, cause the computing device to remove a word region in response to a lack of core text region pixels in the word region.

Example 22 may include the at least one computer readable medium of Example 19, comprising a further set of instructions, which when executed by the computing device, cause the computing device to train the scene text detection network with a plurality of image training samples, the scene text detection network including a dense features portion, a reverse connections portion communicatively coupled to the dense features portion, and a stage losses portion communicatively coupled to the reverse connections portion.

Example 23 may include the at least one computer readable medium of Example 22, comprising a further set of instructions, which when executed by the computing device, cause the computing device to supporting large receptive field features for the dense features portion.

Example 24 may include the at least one computer readable medium of any of Examples 22 to 23, comprising a further set of instructions, which when executed by the computing device, cause the computing device to train the scene text detection network with a plurality of online hard examples mining training samples.

Example 25 may include a text detector apparatus, comprising means for to applying a trained scene text detection network to an image to identify a core text region, a supportive text region, and a background region of the image, and means for detecting text in the image based on the identified core text region and supportive text region.

Example 26 may include the apparatus of Example 25, further comprising means for splitting connected words into one or more word regions based on the identified core text region and supportive text region.

Example 27 may include the apparatus of Example 25, further comprising means for removing a word region in response to a lack of core text region pixels in the word region.

Example 28 may include the apparatus of Example 25, further comprising means for training the scene text detection network with a plurality of image training samples, the scene text detection network including a dense features portion, a reverse connections portion communicatively coupled to the dense features portion, and a stage losses portion communicatively coupled to the reverse connections portion.

Example 29 may include the apparatus of Example 28, further comprising means for supporting large receptive field features for the dense features portion.

Example 30 may include the apparatus of any of Examples 28 to 29, further comprising means for training the scene text detection network with a plurality of online hard examples mining training samples.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1-24. (canceled)

25. An electronic processing system, comprising:
a processor;
memory communicatively coupled to the processor; and
logic communicatively coupled to the processor to:
apply a trained scene text detection network to an image to identify a core text region, a supportive text region, and a background region of the image, and
detect text in the image based on the identified core text region and supportive text region.

26. The system of claim 25, wherein the logic is further to:
split connected words into one or more word regions based on the identified core text region and supportive text region.

27. The system of claim 25, wherein the logic is further to:
remove a word region in response to a lack of core text region pixels in the word region.

28. The system of claim 25, wherein the logic is further to:
train the scene text detection network with a plurality of image training samples, the scene text detection network including a dense features portion, a reverse connections portion communicatively coupled to the dense features portion, and a stage losses portion communicatively coupled to the reverse connections portion.

29. The system of claim 28, wherein the logic is further to:
support large receptive field features for the dense features portion.

30. The system of claim 28, wherein the logic is further to:
train the scene text detection network with a plurality of online hard examples mining training samples.

31. A semiconductor package apparatus, comprising:
one or more substrates; and
logic coupled to the one or more substrates, wherein the logic is at least partly implemented in one or more of configurable logic and fixed-functionality hardware logic, the logic coupled to the one or more substrates to:
apply a trained scene text detection network to an image to identify a core text region, a supportive text region, and a background region of the image, and
detect text in the image based on the identified core text region and supportive text region.

32. The apparatus of claim 31, wherein the logic is further to:
split connected words into one or more word regions based on the identified core text region and supportive text region.

33. The apparatus of claim 31, wherein the logic is further to:
remove a word region in response to a lack of core text region pixels in the word region.

34. The apparatus of claim 31, wherein the logic is further to:
train the scene text detection network with a plurality of image training samples, the scene text detection network including a dense features portion, a reverse connections portion communicatively coupled to the dense features portion, and a stage losses portion communicatively coupled to the reverse connections portion.

35. The apparatus of claim 34, wherein the logic is further to:
support large receptive field features for the dense features portion.

36. The apparatus of claim 34, wherein the logic is further to:
train the scene text detection network with a plurality of online hard examples mining training samples.

37. A method of detecting text, comprising:
applying a trained scene text detection network to an image to identify a core text region, a supportive text region, and a background region of the image; and
detecting text in the image based on the identified core text region and supportive text region.

38. The method of claim 37, further comprising:
splitting connected words into one or more word regions based on the identified core text region and supportive text region.

39. The method of claim 37, further comprising:
removing a word region in response to a lack of core text region pixels in the word region.

40. The method of claim 37, further comprising:
training the scene text detection network with a plurality of image training samples, the scene text detection network including a dense features portion, a reverse connections portion communicatively coupled to the dense features portion, and a stage losses portion communicatively coupled to the reverse connections portion.

41. The method of claim 40, further comprising:
supporting large receptive field features for the dense features portion.

42. The method of claim 40, further comprising:
training the scene text detection network with a plurality of online hard examples mining training samples.

43. At least one computer readable medium, comprising a set of instructions, which when executed by a computing device, cause the computing device to:
apply a trained scene text detection network to an image to identify a core text region, a supportive text region, and a background region of the image; and
detect text in the image based on the identified core text region and supportive text region.

44. The at least one computer readable medium of claim 43, comprising a further set of instructions, which when executed by the computing device, cause the computing device to:
split connected words into one or more word regions based on the identified core text region and supportive text region.

45. The at least one computer readable medium of claim 43, comprising a further set of instructions, which when executed by the computing device, cause the computing device to:
remove a word region in response to a lack of core text region pixels in the word region.

46. The at least one computer readable medium of claim 43, comprising a further set of instructions, which when executed by the computing device, cause the computing device to:
train the scene text detection network with a plurality of image training samples, the scene text detection network including a dense features portion, a reverse connections portion communicatively coupled to the dense features portion, and a stage losses portion communicatively coupled to the reverse connections portion.

47. The at least one computer readable medium of claim 46, comprising a further set of instructions, which when executed by the computing device, cause the computing device to:
supporting large receptive field features for the dense features portion.

48. The at least one computer readable medium of claim 46, comprising a further set of instructions, which when executed by the computing device, cause the computing device to:
train the scene text detection network with a plurality of online hard examples mining training samples.
